(19) United States
(12) Patent Application Publication
(10) Pub. No.: US 2015/0338009 A1
(43) Pub. Date: Nov. 26, 2015

(54) Siphon apparatus

(71) Applicants: Chung Wei Huang, Taichung (TW); Wen-Hung Li, Tainan (TW); Cheng Yu Huang, Taichung (TW)

(72) Inventors: Chung Wei Huang, Taichung (TW); Wen-Hung Li, Tainan (TW); Cheng Yu Huang, Taichung (TW)

(21) Appl. No.: 14/818,307

(22) Filed: Aug. 5, 2015

(51) Int. Cl. F16L 43/00

(52) U.S. Cl. CPC F16L 43/00

(57) ABSTRACT

A siphon includes a hollow member including an upper enlargement, intermediate external threads, and lower external threads; an internally threaded ring secured to the intermediate external threads; a guide tube including a plurality of annular grooves on an outer surface, the guide tube being moveably partially disposed in the hollow member; a plurality of O-rings in the annular grooves; a tubular member around the guide tube and secured to the upper enlargement, the tubular member including a plurality of openings; and a sleeve moveably put on the tubular member.

### BACKGROUND OF THE INVENTION

1. Field of the Invention

The invention relates to siphon and more particularly to a siphon apparatus.

2. Description of Related Art

A conventional system comprises a pump for drawing water and waste from an aquarium tank to a flowerpot to supply nutrients to the growth of plants cultivated therein, and a siphon tube for drawing water back from the flowerpot to the tank to supply nutrients to fish in the tank.

However, the siphon tube is not capable of adjusting water level of the tank. Plants in the flowerpot may die due to long time submersion in the water.

Thus, the need for improvement still exists.

### SUMMARY OF THE INVENTION

It is therefore one object of the invention to provide a siphon apparatus comprising a hollow member including an upper enlargement, intermediate external threads, and lower external threads; an internally threaded ring secured to the intermediate external threads; a guide tube including a plurality of annular grooves disposed on an outer surface, the guide tube being moveably partially disposed in the hollow member; a plurality of O-rings disposed in the annular grooves; a tubular member disposed around the guide tube and secured to the upper enlargement, the tubular member including a plurality of openings; and a sleeve moveably put on the tubular member.

The above and other objects, features and advantages of the invention will become apparent from the following detailed description taken with the accompanying drawings.

### BRIEF DESCRIPTION OF THE DRAWINGS

FIG. 1 is an exploded view of a siphon apparatus according to the invention;

FIG. 2 is a perspective of the siphon apparatus;

FIG. 3 is a schematic side view in part section of a first system incorporating the siphon apparatus, an aquarium tank, and a flowerpot with the protective sleeve removed;

FIG. 4 is an enlarged view of the siphon apparatus of FIG. 3;

FIG. 5 is a view similar to FIG. 4 showing a water level adjustment of the siphon apparatus;

FIG. 6 is a view similar to FIG. 4 showing after water level adjustment of the siphon apparatus; and

FIG. 7 is a schematic side view in part section of a second system incorporating the siphon apparatus, the aquarium tank, and the flowerpot.

### DETAILED DESCRIPTION OF THE INVENTION

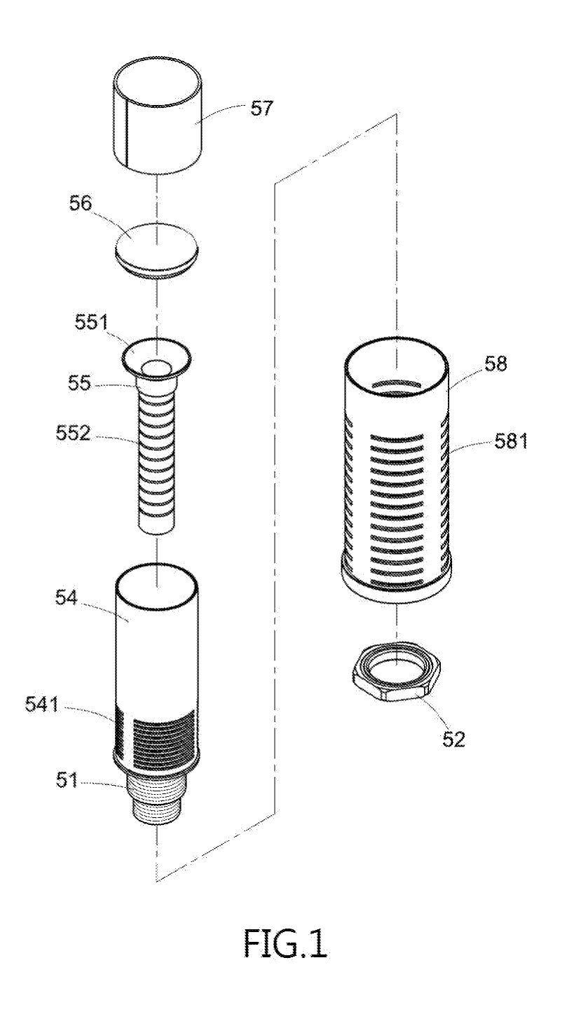

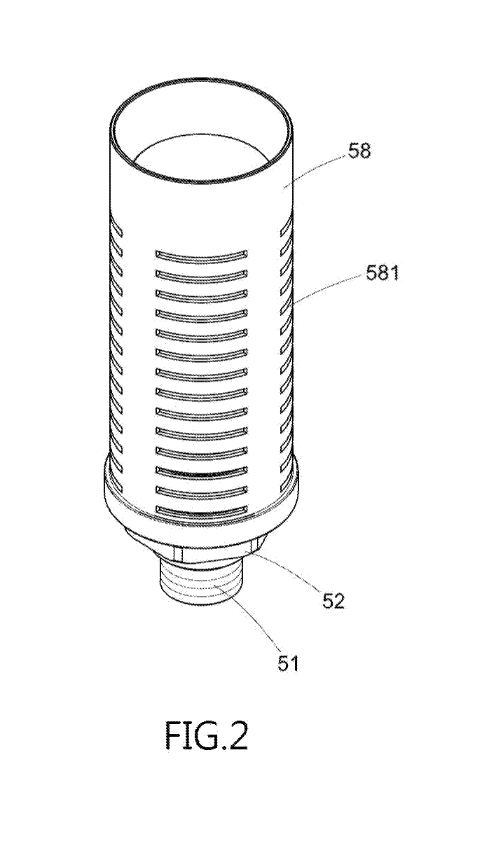

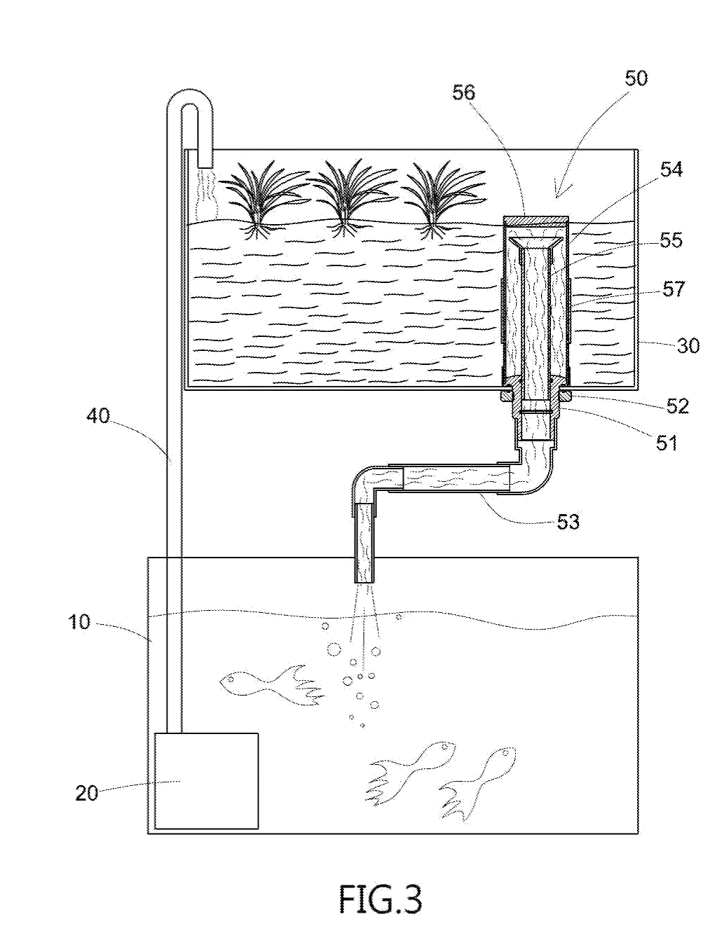

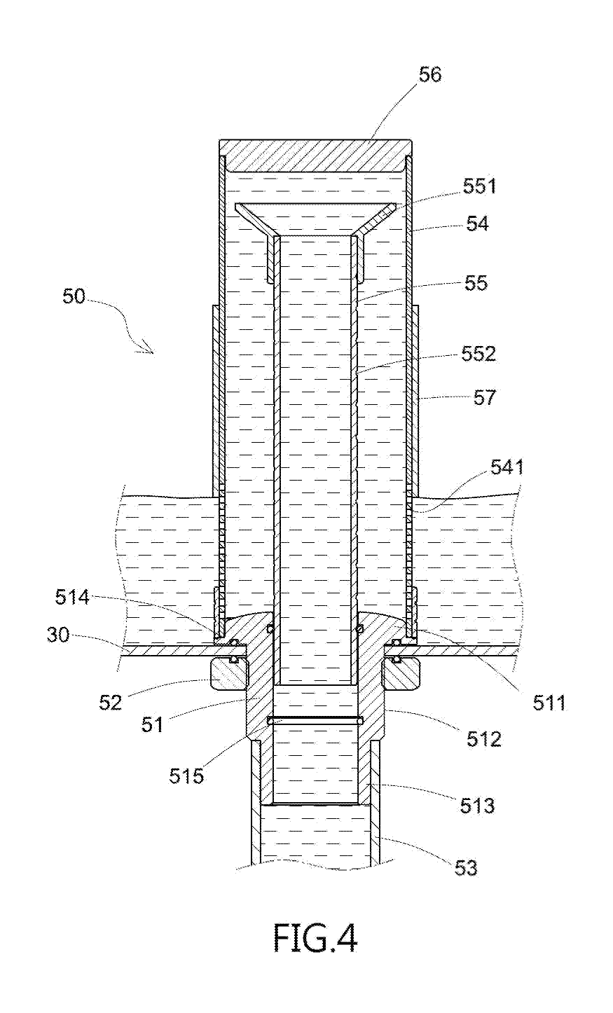

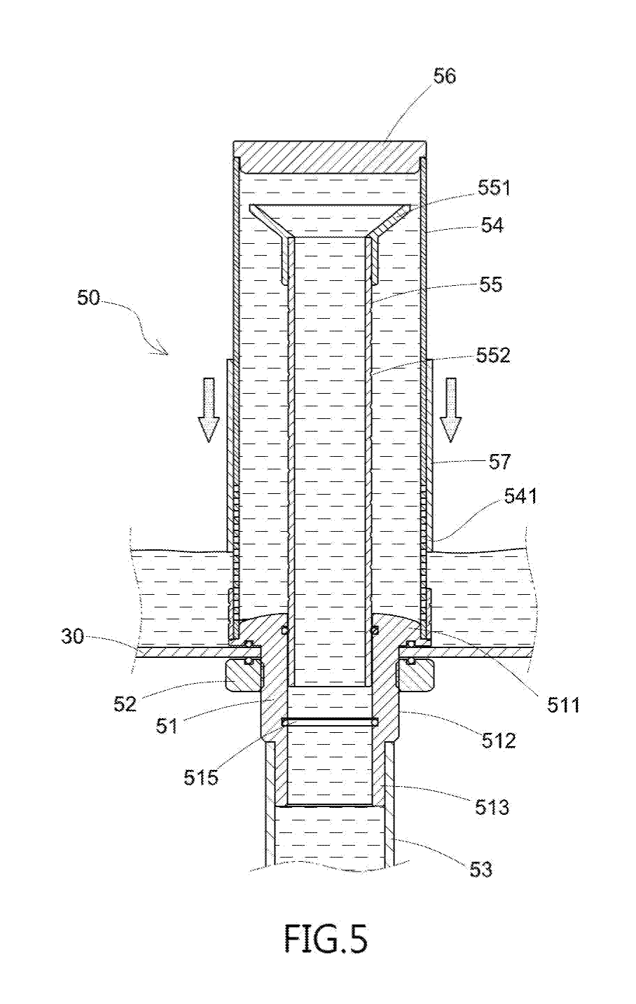

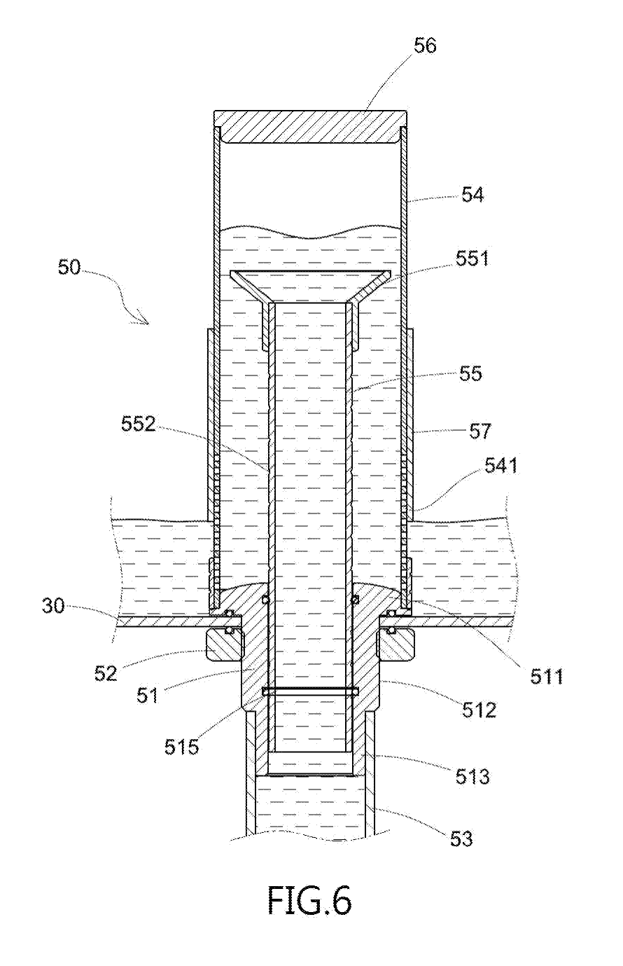

Referring to FIGS. 1 to 6, a first system comprising a siphon apparatus 50, an aquarium tank 10, a flowerpot 30, and a pump 20 submerged in the aquarium tank 10 for supplying water to the flowerpot 30 via a tube 40 of the invention is shown.

The siphon apparatus 50 comprises the following components. A cylindrical hollow member 51 includes an upper enlargement 511, intermediate external threads 512, lower external threads 513, and an annular flange 514 on a periphery of the enlargement 511. The enlargement 511 and the flange 514 are rested on bottom of the flowerpot 30. An internally threaded ring 52 is secured to the intermediate external threads 512 to fasten the hollow member 51. A guide tube 55 includes a funnel 551 on top and annular grooves 552 on an outer surface. The guide tube 55 is moveably fastened in the hollow member 51 by disposing one or more of O-rings 515 in the grooves 552. A pipe 53 has one end secured to the lower external threads 513 and the other end extending into the aquarium tank 10 so that water in the guide tube 55 flows to the aquarium tank 10 via the hollow member 51 and the pipe 53.

A tubular member 54 is around the guide tube 55, secured to the flange 514, and includes arc openings 541 on a lower portion. A cap 56 is disposed on top of the tubular member 54 for sealing the tubular member 54. A sleeve 57 is put on the tubular member 54. For adjusting water level of the tubular member 54, a person may move down the sleeve 57 to decrease the number of the openings 541. Next, the person may remove the cap 56 and push down the guide tube 55. As a result, the water level of the tubular member 54 is dropped.

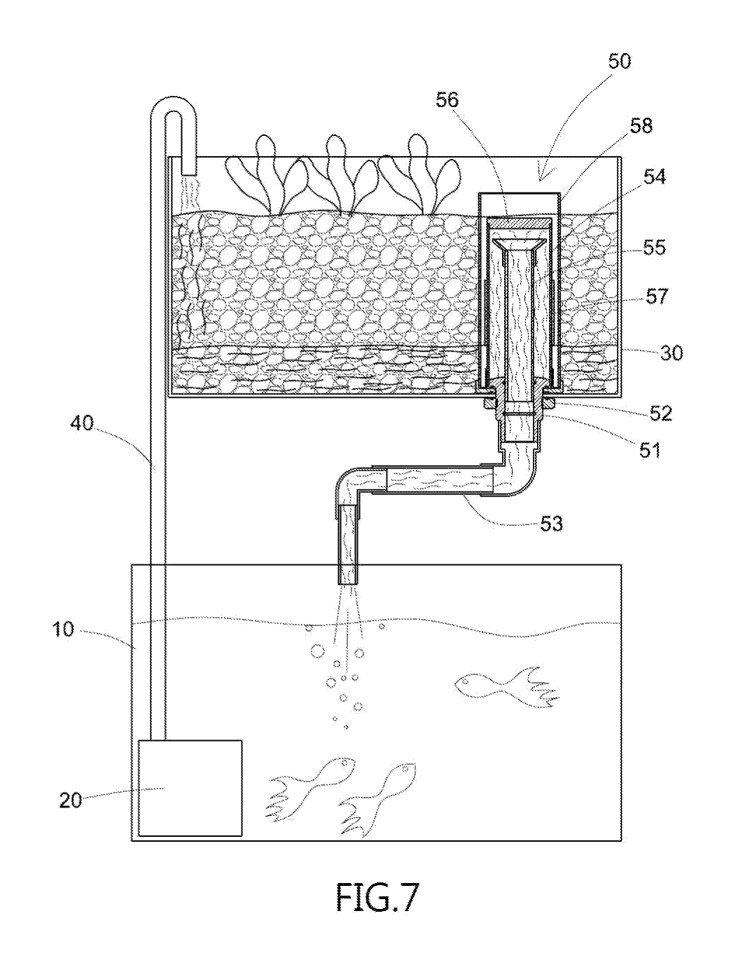

Referring to FIG. 7 in conjunction with FIG. 1, a second system comprising the siphon apparatus 50, the aquarium tank 10, the flowerpot 30, and the pump 20 submerged in the aquarium tank 10 for supplying water to the flowerpot 30 via the tube 40 of the invention is shown. The difference between the first system and the second system is that a protective sleeve 58 is included in the second system. The protective sleeve 58 includes arc openings 581. The protective sleeve 58 is around the sleeve 57 and secured to the bottom of the flowerpot 30.

While the invention has been described in terms of preferred embodiments, those skilled in the art will recognize that the invention can be practiced with modifications within the spirit and scope of the appended claims.

What is claimed is:

1. A siphon apparatus comprising:
a hollow member including an upper enlargement, intermediate external threads, and lower external threads;
an internally threaded ring secured to the intermediate external threads;
a guide tube including a plurality of annular grooves disposed on an outer surface, the guide tube being moveably partially disposed in the hollow member;
a plurality of O-rings disposed in the annular grooves;
a tubular member disposed around the guide tube and secured to the upper enlargement, the tubular member including a plurality of openings; and
a sleeve moveably put on the tubular member.
